(19) United States
(12) Patent Application Publication
(10) Pub. No.: US 2012/0121191 A1
(43) Pub. Date: May 17, 2012

(54) IMAGE SEPARATION APPARATUS AND METHOD

(75) Inventors: Seok-Bin KANG, Daejeon (KR); Jun-Sup LEE, Daejeon (KR); Jong-Gook KO, Daejeon (KR); Su-Woong LEE, Daejeon (KR); Jun-Suk LEE, Daejeon (KR)

(73) Assignee: Electronics and Telecommunications Research Institute, Daejeon-city (KR)

(21) Appl. No.: 13/297,718

(22) Filed: Nov. 16, 2011

(30) Foreign Application Priority Data
Nov. 16, 2010 (KR) 10-2010-0114073

(51) Int. Cl. G06K 9/48

(52) U.S. Cl. 382/199

(57) ABSTRACT

The present invention provides an image separation apparatus and method. The image separation apparatus includes an image reception unit for receiving an input image. A background model generation unit generates a background model corresponding to the input image. A foreground/background separation unit performs a task of determining using the background model whether reference pixels among all pixels of the input image belong to a foreground or a background, and performs a task of estimating, based on results of the foreground/background determination task, whether remaining pixels other than the reference pixels belong to the foreground or the background.

### CROSS REFERENCE TO RELATED APPLICATION

This application claims the benefit of Korean Patent Application No. 10-2010-0114073, filed on Nov. 16, 2010, which is hereby incorporated by reference in its entirety into this application.

### BACKGROUND OF THE INVENTION

1. Technical Field

The present invention relates generally to an image separation apparatus and method and, more particularly, to an image separation apparatus and method for separating a background image and a foreground image.

2. Description of the Related Art

A conventional image separation apparatus receives an input image from an image input device, sets a background model which will be a reference for separating a background and a foreground, and determines whether a relevant pixel of the input image belongs to the background or the foreground on the basis of the results of the determination about whether each pixel of the input image matches the background model.

The performance of such a conventional image separation apparatus is determined by the speed at which a foreground and a background are separated. However, since the determination of whether a relevant pixel belongs to a foreground or a background is performed with respect to all pixels of an input image, a problem may arise in that the performance of the image separation apparatus is deteriorated.

### SUMMARY OF THE INVENTION

Accordingly, the present invention has been made keeping in mind the above problems occurring in the prior art, and an object of the present invention is to provide an image separation apparatus and method, which can improve the speed at which an input image is separated into a foreground and a background by performing dynamic sampling.

In accordance with an aspect of the present invention to accomplish the above object, there is provided an image separation apparatus, including an image reception unit for receiving an input image, a background model generation unit for generating a background model corresponding to the input image, and a foreground/background separation unit for performing a task of determining using the background model whether reference pixels among all pixels of the input image belong to a foreground or a background, and performing a task of estimating, based on results of the foreground/background determination task, whether remaining pixels other than the reference pixels belong to the foreground or the background.

Preferably, the foreground/background separation unit may adjust a pixel pitch based on the results of the foreground/background determination task, and then sets the reference pixels.

Preferably, the foreground/background separation unit may include a pixel management unit for setting the reference pixels while adjusting the pixel pitch using dynamic sampling, and for generating a determination criterion image on which the results of the foreground/background determination task are indicated.

Preferably, the foreground/background separation unit may detect reference model pixels, locations of which correspond to locations of the respective reference pixels, from the background model, compare background data about the reference model pixels with pixel data about the reference pixels, and then generate the determination criterion image.

Preferably, the foreground/background separation unit may include a foreground/background estimation unit for performing the task of estimating using the determination criterion image whether the remaining pixels belong to the foreground or the background, thus generating a resulting separated image for the input image.

Preferably, the foreground/background separation unit may include an ultimate result output unit for outputting and providing results of the resulting separated image.

In accordance with another aspect of the present invention to accomplish the above object, there is provided an image separation method, including receiving an input image and generating a background model, performing a task of determining using the background model whether reference pixels among all pixels of the input image belong to a foreground or a background, generating a determination criterion image on which the results of the foreground/background determination task are indicated, and performing a task of estimating using the determination criterion image whether remaining pixels other than the reference pixels belong to the foreground or the background.

Preferably, the performing the foreground/background determination task may include adjusting a pixel pitch based on the results of the foreground/background determination task, and setting the reference pixels according to the pixel pitch.

Preferably, the performing the foreground/background determination task may further include detecting reference model pixels, locations of which correspond to locations of the respective reference pixels, from the background model, and comparing background data about the reference model pixels with pixel data about the reference pixels, and then performing the foreground/background determination task.

Preferably, the performing the foreground/background estimation task may include indicating results of the foreground/background estimation task performed on all the pixels of the input image, and then generating a resulting separated image, and outputting and providing results of the resulting separated image.

In accordance with a further aspect of the present invention to accomplish the above object, there is provided an image separation method, including detecting a reference pixel spaced apart from a previous reference pixel of an input image by a first pixel pitch, determining whether a location of the reference pixel falls within an entire pixel range of the input image, detecting a reference model pixel corresponding to the reference pixel from a background model generated to correspond to the input image, and determining whether pixel data about the reference pixel is identical to background data about the reference model pixel, adjusting the first pixel pitch to a second pixel pitch based on results of the determination, and then setting a subsequent reference pixel.

Preferably, the determining may include detecting pixel data about the reference pixel if the location of the reference pixel falls within the entire pixel range.

Preferably, the setting the subsequent reference pixel may include if the pixel data is identical to the background data, reducing the first pixel pitch, and if the pixel data is not identical to the background data, increasing the first pixel pitch.

Preferably, the setting the subsequent reference pixel may include determining whether the first pixel pitch is less than a preset value, and setting the first pixel pitch to the preset value if the first pixel pitch is less than the preset value.

In accordance with yet another aspect of the present invention to accomplish the above object, there is provided an image separation method, including generating a determination criterion image for reference pixels among all pixels of an input image, determining whether a first pixel of all the pixels of the input image falls within an entire pixel range, and determining whether a location of the first pixel is identical to a location of any one of the reference pixels, and then performing a task of estimating whether the first pixel belongs to a foreground or a background.

Preferably, the performing the foreground/background estimation task may include, if the location of the first pixel is identical to that of any one of the reference pixels, indicating, on the first pixel, results of determination of whether the identical reference pixel belongs to the foreground or the background.

Preferably, the performing the foreground/background estimation task may include, if the location of the first pixel is not identical to that of any one of the reference pixels, selecting a reference pixel closest to the first pixel from the determination criterion image, and indicating, on the first pixel, results of determination of whether the closest reference pixel belongs to the foreground or the background.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an example in which a conventional image separation apparatus separates a background image and a foreground image;

FIG. 2 is a diagram schematically showing an image separation apparatus according to an embodiment of the present invention;

FIG. 3 is a diagram schematically showing the foreground/background separation unit of the image separation apparatus of FIG. 2;

FIG. 4 is a flowchart showing a method in which the pixel management unit of the foreground/background separation unit of FIG. 3 adjusts a pixel pitch using dynamic sampling;

FIG. 5 is a flowchart showing a method in which the foreground/background estimation unit of the foreground/background separation unit of FIG. 3 estimates whether the remaining pixels other than reference pixels belong to a foreground or a background;

FIG. 6 is a diagram showing an embodiment in which the image separation apparatus of FIG. 2 separates a foreground and a background by adjusting a pixel pitch using dynamic sampling; and

FIG. 7 is a flowchart showing a sequence in which the image separation apparatus of FIG. 2 separates a foreground and a background by adjusting a pixel pitch using dynamic sampling.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

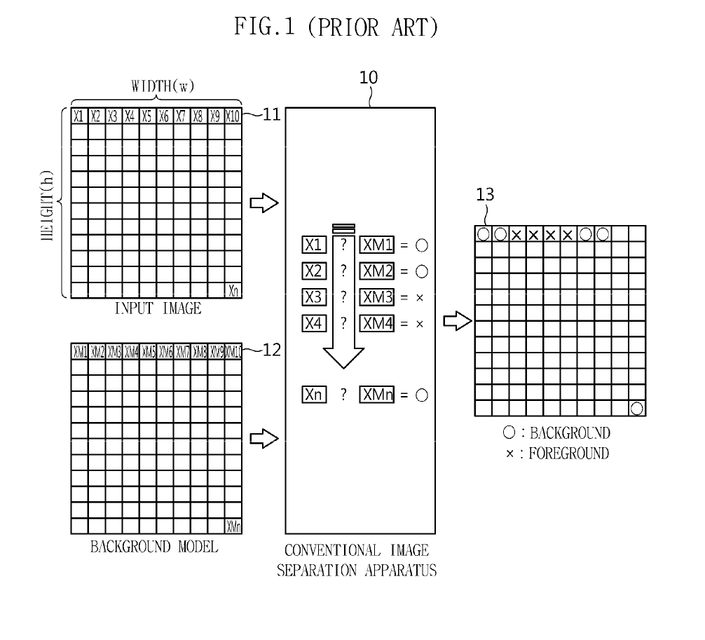

FIG. 1 is a diagram showing an example in which a conventional image separation apparatus separates a background image and a foreground image.

Referring to FIG. 1, a conventional image separation apparatus 10 receives an input image and generates a background model for the input image. Further, the image separation apparatus 10 determines whether a relevant region is a background region or a foreground region according to the degree to which the input image matches the background model.

The conventional image separation apparatus generates the background model using static sampling or dynamic sampling.

Static sampling is a method that generates a background model in an initial stage and subsequently separates an image using a background model identical to the initially generated background model. Dynamic sampling is a method that generates a background model in an initial stage similarly to the static sampling, but subsequently separates an image while revising the background model during the execution of image separation. Representatives of such dynamic sampling include a Mixture of Gaussian (MoG), Kernel Density Estimation (KDE), the Mahalanobis distance, etc.

These background model construction methods basically generate a statistical background model for all pixels of an input image. That is, the conventional image separation apparatus searches for all pixels or space down-sampled pixels of the input image, and thus separates the input image into a foreground image and a background image.

For example, the conventional image separation apparatus 10 generates a background model 12 corresponding to an input image 11 when the input image 11 is received. Further, the conventional image separation apparatus 10 performs a foreground/background determination task of comparing n pixels of the input image 11 with n pixels of the background model 12 that is formed to correspond to the input image 11, and determining whether a relevant pixel belongs to a background image (region) or a foreground image (region).

In this way, since the conventional image separation apparatus 10 compares all the pixels of the input image 11 with all the pixels of the background model 12 formed to correspond to the pixels of the input image 11, and then separates the input image 11 into the background image and the foreground image, a problem arises in that the performance of the separation of the foreground and background of an image is deteriorated.

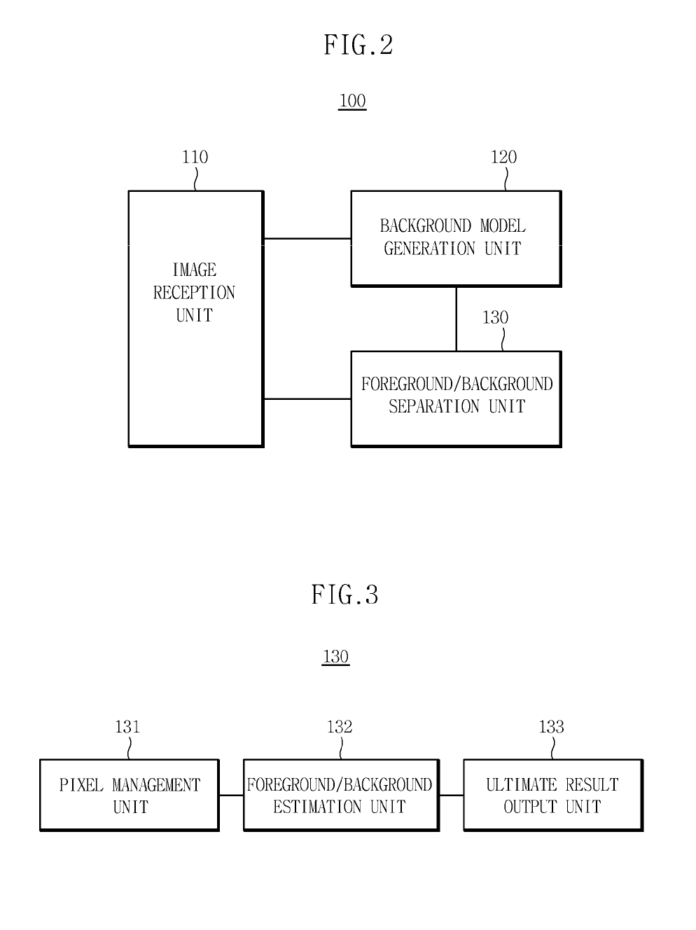

Hereinafter, an image separation apparatus and method capable of improving the speed at which an image is separated into a foreground and a background in order to solve the above problem will be described in detail with reference to FIGS. 2 to 7.

FIG. 2 is a diagram schematically showing an image separation apparatus according to an embodiment of the present invention. FIG. 3 is a diagram schematically showing the foreground/background separation unit of the image separation apparatus of FIG. 2.

As shown in FIG. 2, an image separation apparatus 100 according to an embodiment of the present invention includes an image reception unit 110, a background model generation unit 120, and a foreground/background separation unit 130.

The image reception unit 110 receives an image captured by an image input device such as a camera (not shown). The input image according to the embodiment of the present invention is assumed to have m pixels. Further, the image reception unit 110 transfers the input image both to the background model generation unit 120 and to the foreground/background separation unit 130.

The background model generation unit 120 generates a background model including m pixels formed to correspond to the input image. Further, the background model generation unit 120 transfers the background model to the foreground/background separation unit 130.

The foreground/background separation unit 130 receives the input image from the image reception unit 110, receives the background model from the background model generation unit 120, separates the input image into a background image and a foreground image, indicates the results of the separation, and then generates a resulting separated image. Such a foreground/background separation unit 130 includes a pixel management unit 131, a foreground/background estimation unit 132, and an ultimate result output unit 133, as shown in FIG. 3.

The pixel management unit 131 sets reference pixels while adjusting a pixel pitch using dynamic sampling and determines whether each reference pixel belongs to a foreground image or a background image, in order to separate the input image into the foreground image and the background image (hereinafter referred to as a “foreground/background determination task”). Further, the pixel management unit 131 generates a determination criterion image on which the results of the foreground/background determination task (hereinafter referred to as “determination results”) are indicated, and transfers the determination criterion image to the foreground/background estimation unit 132. Here, the reference pixels are pixels that are referred to so as to estimate whether the remaining pixels of the input image, located adjacent to and between the reference pixels, belong to the foreground region (image) or the background region (image).

The foreground/background estimation unit 132 receives the determination criterion image. Further, the foreground/background estimation unit 132 estimates whether the remaining pixels located between the reference pixels belong to the foreground image or the background image, on the basis of the determination results for the reference pixels indicated on the determination criterion image (hereinafter referred to as a “foreground/background estimation task”), and then generates a resulting separated image. The foreground/background estimation unit 132 transmits the resulting separated image to the ultimate result output unit 133 if the foreground/background estimation task on all the pixels of the input image has been completed.

The ultimate result output unit 133 receives the resulting separated image from the foreground/background estimation unit 132, and outputs and provides the determination results indicated on the resulting separated image.

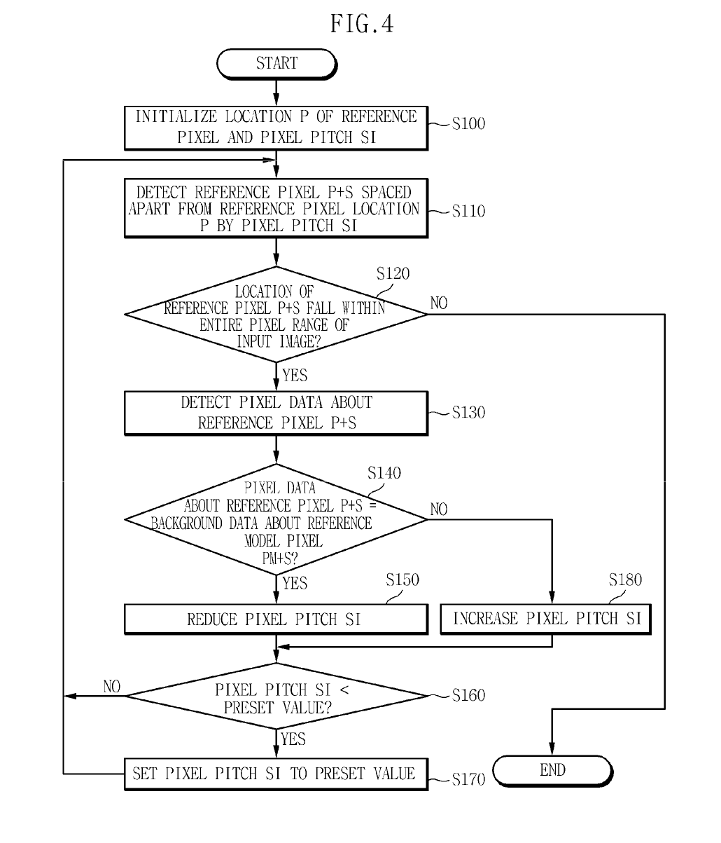

FIG. 4 is a flowchart showing a method in which the pixel management unit of the foreground/background separation unit of FIG. 3 adjusts a pixel pitch using dynamic sampling.

As shown in FIG. 4, when an input image is received, the pixel management unit 131 of the foreground/background separation unit 130 according to an embodiment of the present invention initializes the location of a reference pixel P, among all m pixels of the input image, and a pixel pitch SI to “0” at step S100. The pixel management unit 131 detects a reference pixel P+S spaced apart from the location of the reference pixel P by the pixel pitch SI at step S110.

Further, the pixel management unit 131 determines whether the location of the reference pixel P+S falls within the entire pixel range of the input image at step S120.

If it is determined at step S120 that the location of the reference pixel P+S does not fall within the entire pixel range of the input image, the pixel management unit 131 terminates the task of adjusting a pixel pitch because the reference pixel P+S does not fall within the entire pixel range of the input image.

If it is determined at step S120 that the location of the reference pixel P+S falls within the entire pixel range of the input image, the pixel management unit 131 detects pixel data about the reference pixel P+S at step S130. The pixel management unit 131 determines whether the pixel data about the reference pixel P+S is identical to background data about a reference model pixel PM+S at step S140. Here, the reference model pixel PM+S is a pixel at the location, corresponding to that of the reference pixel P+S, in the background model formed to correspond to the input image.

If it is determined at step S140 that the pixel data about the reference pixel P+S is identical to the background data about the reference model pixel PM+S, the pixel management unit 131 reduces the pixel pitch SI at step S150. In this case, the pixel management unit 131 reduces the pixel pitch SI using any one of methods \textcircled{1} to \textcircled{3} indicated in Equation 1. Further, the pixel management unit 131 determines whether the reduced pixel pitch SI is less than 1 at step S160.

\textcircled{1} SI=SI/X (where X is any constant)

\textcircled{2} SI=SI−X (where X is any constant)

\textcircled{3} SI=logₓ(SI) (where X is any constant) (1)

If it is determined at step S160 that the reduced pixel pitch SI is less than a preset value, for example, “1”, the pixel management unit 131 sets the pixel pitch SI to the preset value, and returns to step S110 to repeat the procedure starting from step S110 at step S170. If it is determined at step S160 that the reduced pixel pitch SI is not less than the preset value, the pixel management unit 131 returns to step S110 to repeat the procedure starting from step S110.

If it is determined at step S140 that the pixel data about the reference pixel P+S is not identical to the background data about the reference model pixel PM+S, the pixel management unit 131 increases the pixel pitch SI at step S180. In this case, the pixel management unit 131 increases the pixel pitch SI using any one of methods \textcircled{1} to \textcircled{3} indicated in Equation 2. The pixel management unit 131 determines whether the increased pixel pitch SI is less than the preset value at step S160, and performs a subsequent procedure on the basis of the results of the determination.

\textcircled{1} SI=SI*X (where X is any constant)

\textcircled{2} SI=SI+X (where X is any constant)

\textcircled{3} SI=SÎX (where X is any constant) (2)

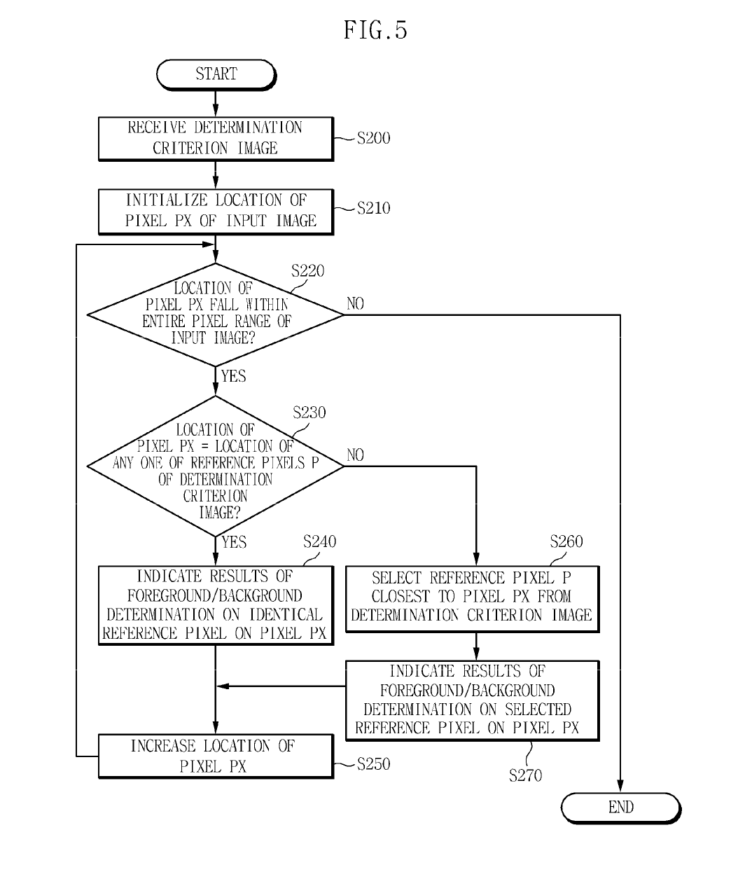

FIG. 5 is a flowchart showing a method in which the foreground/background estimation unit of the foreground/background separation unit of FIG. 3 estimates whether the remaining pixels other than reference pixels belong to a foreground or a background.

As shown in FIG. 5, the foreground/background estimation unit 132 of the foreground/background separation unit 130 according to an embodiment of the present invention receives a determination criterion image from the pixel management unit 131 at step S200. The foreground/background estimation unit 132 initializes the location of a pixel PX of an input image at step S210. The foreground/background estimation unit 132 determines whether the location of the pixel PX falls within the entire pixel range of the input image at step S220.

If it is determined at step S220 that the location of the pixel PX falls within the entire pixel range of the input image, the foreground/background estimation unit 132 determines whether the location of the pixel PX is identical to that of any one of reference pixels P indicated on the determination criterion image at step S230.

If it is determined at step S230 that the location of the pixel PX is identical to that of any one of the reference pixels P indicated on the determination criterion image, the foreground/background estimation unit 132 indicates on the pixel PX the results of the determination of whether a reference pixel P, the location of which is identical to that of the pixel PX, belongs to the foreground or the background, that is, indicates the results of the determination on a resulting separated image at step S240. Furthermore, the foreground/background estimation unit 132 increases the location of the pixel PX, and performs the subsequent procedure starting from step S220 to estimate whether a subsequent pixel PX belongs to the foreground or the background at step S250.

If it is determined at step S230 that the location of the pixel PX is not identical to that of any one of the reference pixels P indicated on the determination criterion image, the foreground/background estimation unit 132 selects some other reference pixel P adjacent to the pixel PX from the determination criterion image at step S260. The foreground/background estimation unit 132 indicates on the pixel PX the results of the determination of whether the other selected reference pixel P belongs to the foreground or the background, that is, indicates the determination results on a resulting separated image at step S270. Further, the foreground/background estimation unit 132 performs a procedure starting from step S250 to estimate whether a subsequent pixel PX belongs to the foreground or the background.

Meanwhile, if it is determined at step S220 that the location of the pixel PX does not fall within the entire pixel range of the input image, the foreground/background estimation unit 132 terminates the foreground/background estimation task for the input image because the pixel PX does not fall within the entire pixel range of the input image.

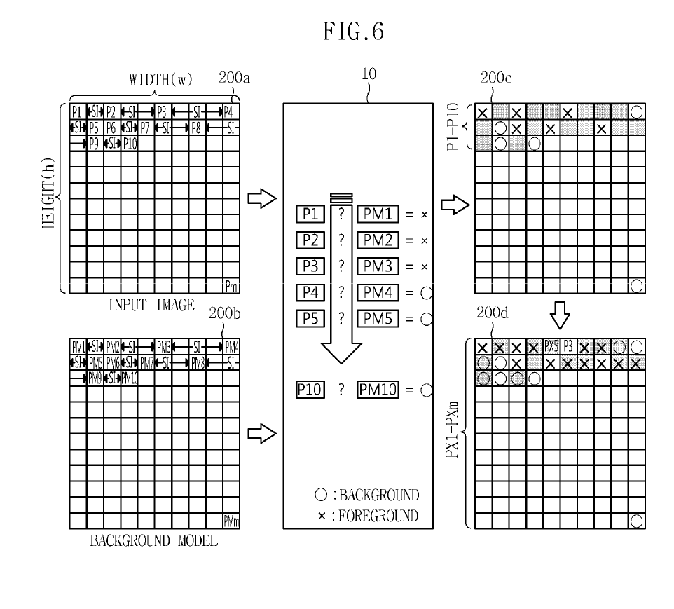

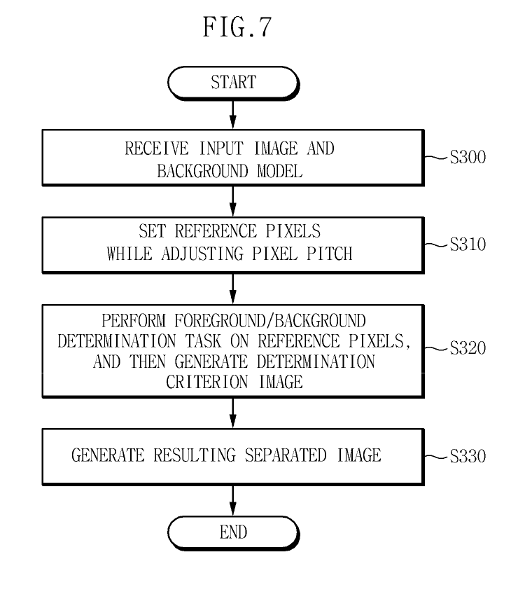

FIG. 6 is a diagram showing an embodiment in which the image separation apparatus of FIG. 2 separates a foreground and a background by adjusting a pixel pitch using dynamic sampling. FIG. 7 is a flowchart showing a sequence in which the image separation apparatus of FIG. 2 separates a foreground and a background by adjusting a pixel pitch using dynamic sampling.

Referring to FIGS. 6 and 7, the foreground/background separation unit 130 according to the embodiment of the present invention receives an input image 200a from the image reception unit 110 and receives a background model 200b from the background model generation unit 120 at step S300. The foreground/background separation unit 130 sets reference pixels P1 to P10 while adjusting the pixel pitch SI of the input image 200a using dynamic sampling so as to perform a foreground/background determination task for the input image 200a at step S310. In the embodiment of the present invention, a description will be made on the assumption that the number of reference pixels is set to 10.

Further, the foreground/background separation unit 130 compares background data about a reference model pixel PM1 at the location, corresponding to that of a reference pixel P1, in the background model 200b with pixel data about the reference pixel P1, determines whether the reference pixel P1 belongs to a foreground image or a background image, and indicates the results of the determination.

Next, the foreground/background separation unit 130 compares background data about a reference model pixel PM2 at the location, corresponding to that of a subsequent reference pixel P2, in the background model 200b with pixel data about the reference pixel P2, determines whether the reference pixel P2 belongs to the foreground image or the background image, and indicates the results of the determination.

In the same way, the foreground/background separation unit 130 compares background data about reference model pixels PM3 to PM10 at the locations, respectively corresponding to those of reference pixels P3 to P10, in the background model 200b with pixel data about the reference pixels P3 to P10, determines whether the reference pixels P3 to P10 belong to the foreground image or the background image, and indicates the results of the determination.

The foreground/background separation unit 130 repeats the above procedure, and performs the foreground/background determination task on the reference pixels P1 to P10, thus generating a determination criterion image 200c at step S310.

The foreground/background separation unit 130 initializes the location of the pixel PX of the input image 200a, and determines whether the location of the pixel PX is identical to that of any one of the reference pixels P1 to P10 indicated on the determination criterion image 200c.

Further, if the location of the pixel PX is identical to that of any one of the reference pixels P1 to P10 indicated on the determination criterion image 200c, the foreground/background separation unit 130 indicates on the pixel PX the results of the determination of whether the identical reference pixel belongs to the foreground or the background, and then performs the task of estimating whether the pixel PX belongs to the foreground or the background.

If the location of the pixel PX is not identical to that of any one of the reference pixels P1 to P10 indicated on the determination criterion image 200c, the foreground/background separation unit 130 selects a reference pixel closest to the pixel PX from the determination criterion image 200c, indicates on the pixel PX the results of the determination of whether the reference pixel belongs to the foreground or the background, and then performs the task of estimating whether the pixel PX belongs to the foreground or the background.

For example, if the location of a pixel PX5 is not identical to that of any one of the reference pixels P1 to P10 indicated on the determination criterion image 200c, the foreground/background separation unit 130 selects a reference pixel P3 closest to the pixel PX5 from the determination criterion image 200c, indicates on the pixel PX5 the results of the determination of whether the reference pixel P3 belongs to the foreground or the background, and then performs the task of estimating whether the pixel PX5 belongs to the foreground or the background.

When the same procedure is repeated and then the foreground/background estimation task on all the pixels of the input image 200a has been completed for the last pixel of the input image 200a, the foreground/background separation unit 130 outputs and provides a resulting region-separated image 200d generated by indicating the results of the determination at step S320.

As described above, the image separation apparatus 100 according to the embodiment of the present invention sets reference pixels by adjusting a pixel pitch using dynamic sampling based on the results of the determination of previous reference pixels and performs a foreground/background estimation task on the remaining pixels on the basis of the results of the task of determining whether the reference pixels belong to a foreground or a background, in order to separate an input image into a foreground image and a background image. Therefore, the image separation apparatus can shorten the time required to separate an input image into a foreground image and a background image. As a result, the performance of the image separation apparatus is improved, so that even if a high-resolution image is input, the image can be separated in real time into a foreground image and a background image, and the results of the separation can be obtained.

According to embodiments of the present invention, in order to separate an input image into a foreground image and a background image, reference pixels are set by adjusting a pixel pitch using dynamic sampling based on the results of the determination of previous reference pixels, and a foreground/background estimation task is performed on the remaining pixels on the basis of the results of the task of determining whether the reference pixels belong to a foreground or a background. As a result, the present invention can shorten the time required to separate an input image into a foreground image and a background image. Accordingly, image separation performance is improved, so that even if an image of high resolution is input, the image can be separated in real time into a foreground image and a background image, thus enabling region-separated images to be obtained more rapidly and precisely.

As described above, optimal embodiments of the present invention have been disclosed in the drawings and the present specification. In this case, although specific terms have been used, those terms are merely intended to describe the present invention and are not intended to limit the meanings and the scope of the present invention as disclosed in the accompanying claims. Therefore, those skilled in the art will appreciate that various modifications and other equivalents embodiments are possible from the above-description. Therefore, the technical scope of the present invention should be defined by the technical spirit of the accompanying claims.

What is claimed is:

1. An image separation apparatus, comprising:
an image reception unit for receiving an input image;
a background model generation unit for generating a background model corresponding to the input image; and
a foreground/background separation unit for performing a foreground/background determination task which determines using the background model whether reference pixels among all pixels of the input image belong to a foreground or a background, and performing a task of estimating, based on results of the foreground/background determination task, whether remaining pixels other than the reference pixels belong to the foreground or the background.

2. The image separation apparatus of claim 1, wherein the foreground/background separation unit adjusts a pixel pitch based on the results of the foreground/background determination task, and then sets the reference pixels.

3. The image separation apparatus of claim 2, wherein the foreground/background separation unit comprises a pixel management unit for setting the reference pixels while adjusting the pixel pitch using dynamic sampling, and for generating a determination criterion image on which the results of the foreground/background determination task are indicated.

4. The image separation apparatus of claim 3, wherein the foreground/background separation unit detects reference model pixels, locations of which correspond to locations of the respective reference pixels, from the background model, compares background data about the reference model pixels with pixel data about the reference pixels, and then generates the determination criterion image.

5. The image separation apparatus of claim 3, wherein the foreground/background separation unit comprises a foreground/background estimation unit for performing the task of estimating using the determination criterion image whether the remaining pixels belong to the foreground or the background, thus generating a resulting separated image for the input image.

6. The image separation apparatus of claim 3, wherein the foreground/background separation unit comprises an ultimate result output unit for outputting and providing results of the resulting separated image.

7. An image separation method, comprising:
receiving an input image and generating a background model;
performing a foreground/background determination task which determines using the background model whether reference pixels among all pixels of the input image belong to a foreground or a background;
generating a determination criterion image on which the results of the foreground/background determination task are indicated; and
performing a task of estimating using the determination criterion image whether remaining pixels other than the reference pixels belong to the foreground or the background.

8. The image separation method of claim 7, wherein the performing the foreground/background determination task comprises:
adjusting a pixel pitch based on the results of the foreground/background determination task; and
setting the reference pixels according to the pixel pitch.

9. The image separation method of claim 8, wherein the performing the foreground/background determination task further comprises:
detecting reference model pixels, locations of which correspond to locations of the respective reference pixels, from the background model; and
comparing background data about the reference model pixels with pixel data about the reference pixels.

10. The image separation method of claim 7, wherein the performing the task of estimating further comprises:
indicating results of the task of estimating performed on all the pixels of the input image, and then generating a resulting separated image; and
outputting and providing results of the resulting separated image.

11. An image separation method, comprising:
detecting a reference pixel spaced apart from a previous reference pixel of an input image by a first pixel pitch;
determining whether a location of the reference pixel falls within an entire pixel range of the input image;
detecting a reference model pixel corresponding to the reference pixel from a background model generated to correspond to the input image; and
setting a subsequent reference pixel for determining whether pixel data about the reference pixel is identical to background data about the reference model pixel, and then adjusting the first pixel pitch.

12. The image separation method of claim 11, wherein the determining comprises detecting pixel data about the reference pixel if the location of the reference pixel falls within the entire pixel range.

13. The image separation method of claim 11, wherein the setting the subsequent reference pixel comprises:
if the pixel data is identical to the background data, reducing the first pixel pitch; and
if the pixel data is not identical to the background data, increasing the first pixel pitch.

14. The image separation method of claim 13, wherein the setting the subsequent reference pixel comprises:
determining whether the first pixel pitch is less than a preset value; and
setting the first pixel pitch to the preset value if the first pixel pitch is less than the preset value.

15. An image separation method, comprising:
generating a determination criterion image for reference pixels among all pixels of an input image;
determining whether a first pixel of all the pixels of the input image falls within an entire pixel range; and
determining whether a location of the first pixel is identical to a location of any one of the reference pixels, and then performing a task of estimating whether the first pixel belongs to a foreground or a background.

16. The image separation method of claim 15, wherein the performing the task of estimating comprises, if the location of the first pixel is identical to that of any one of the reference pixels, indicating, on the first pixel, results of determination of whether the identical reference pixel belongs to the foreground or the background.

17. The image separation method of claim 15, wherein the performing the task of estimating comprises:
if the location of the first pixel is not identical to that of any one of the reference pixels, selecting a reference pixel closest to the first pixel from the determination criterion image; and
indicating, on the first pixel, results of determination of whether the closest reference pixel belongs to the foreground or the background.
